(19) United States
(12) Patent Application Publication
(10) Pub. No.: US 2005/0265235 A1
(43) Pub. Date: Dec. 1, 2005

(54) Method, computer program product, and data processing system for improving transaction-oriented client-server application performance

(75) Inventors: Jos Manuel Accapadi, Austin, TX (US); Kavitha Vittal Murthy Baratakke, Austin, TX (US); Andrew Dunshea, Austin, TX (US); Venkat Venkatsubra, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/855,732

(22) Filed: May 27, 2004

(51) Int. Cl. H04L 12/26

(52) U.S. Cl. 370/235

(57) ABSTRACT

A method, computer program product, and a data processing system for processing transactions of a client-server application is provided. A first data set is transmitted from a client to a server. A second data set to be transmitted to the server is received by the client. An evaluation is made to determine whether transmission of the second data set is blocked until receipt of an acknowledgment of the first data set. A number of allowable outstanding acknowledgements is increased responsive to determining that the second data set is blocked from transmission.

### BACKGROUND OF THE INVENTION

1. Technical Field

The present invention relates generally to an improved data processing system and in particular to a method and computer program product for improving the performance of transaction-oriented client-server applications. Still more particularly, the present invention provides a method and computer program product for averting client-server deadlocks in a data processing system network.

2. Description of Related Art

Transaction oriented client-server applications that run over transmission control protocol (TCP) can perform poorly due to latency-inducing routines running at either or both the client and server. For example, the Nagle algorithm introduces delays at the sender side when sending small data segments, for example segments less than a maximum segment size (MSS). The Nagle algorithm was designed to reduce network congestion resulting from small data transfers. The Nagle algorithm restricts TCP transmissions when a TCP connection has outstanding small segment data that has yet to be acknowledged. In conventional implementations of the Nagle algorithm, identification of a single small segment having an outstanding acknowledgement results in the Nagle algorithm blocking transmission of subsequent small segments of a common TCP session until receipt of the outstanding acknowledgement at the sender side.

Additionally, a delayed acknowledgement routine running on a receiver side will sometimes result in a sender-receiver induced deadlock that is only resolved after a delayed acknowledgement timeout. Typical delayed acknowledgement implementations in TCP are 200 milliseconds in duration. Thus, a deadlock between a Nagle induced delay at a sender and a delayed acknowledgement at a receiver may potentially limit exchanges between the client and server to 5 transactions per second. Such a situation may arise when an application issues a request as scattered writes in which data of a request is distributed over a plurality of small frames.

Current solutions to Nagle and delayed acknowledgement induced deadlocks include disabling the Nagle algorithm or the delayed acknowledgement function. The Nagle algorithm may be disabled on a system-wide, interface-specific, or socket-specific basis. In a system-wide disablement of the Nagle algorithm, the Nagle algorithm is disabled on all TCP connections. Such a solution may result in severe application performance degradation. Interface-specific disablement of the Nagle algorithm results in disablement of the Nagle algorithm over a specific interface and may result in application performance degradation for applications utilizing the interface on which the Nagle algorithm is disabled. Socket-specific disablement of the Nagle algorithm requires an application change to disable the Nagle algorithm.

Disablement of the delayed acknowledgement function effects all connections on the system. Additionally, an increase in the number of acknowledgement packets transmitted across the network will result due to the loss of the ability to “piggyback,” that is commonly include, an acknowledgement and application data in a single frame.

Thus, it would be advantageous to provide a routine for improving performance of transaction oriented client-server applications. It would further be advantageous to provide a system for reducing the occurrence of deadlock delays encountered when performing multiple small writes in a client-server application running an instance of the Nagle algorithm on the sender side and a delayed acknowledgement routine on the receiver side.

### SUMMARY OF THE INVENTION

The present invention provides a method, computer program product, and a data processing system for processing transactions of a client-server application. A first data set is transmitted from a client to the server. A second data set to be transmitted to a server is received by the client. An evaluation is made to determine whether transmission of the second data set is blocked until receipt of an acknowledgment of the first data set. A number of allowable outstanding acknowledgements is increased responsive to determining that the second data set is blocked from transmission.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server of the network shown in FIG. 1 in which a preferred embodiment of the present invention may be implemented;

FIG. 3 is a block diagram illustrating a data processing system in which a preferred embodiment of the present invention may be implemented;

FIG. 4 is a diagrammatic illustration of a client-server application in which a preferred embodiment of the present invention may be implemented for advantage.

FIG. 5A is a signal flow diagram between a client and a server in which a deadlock between the client and server is encountered in which a preferred embodiment of the present invention may be implemented for advantage;

FIG. 5B is a signal flow diagram between a client and a server in which the number of outstanding small segments has been increased for improved client-server application performance in accordance with a preferred embodiment of the present invention;

FIG. 6 is a flowchart of a transaction processing routine for evaluating a number of outstanding acknowledgments in accordance with a preferred embodiment of the present invention; and

FIG. 7 is a flowchart of a transaction processing routine that may be implemented in a network stack of a data processing system in accordance with a preferred embodiment of the present invention.

### DETAILED DESCRIPTION OF THE PREFERRED EMBODIMENT

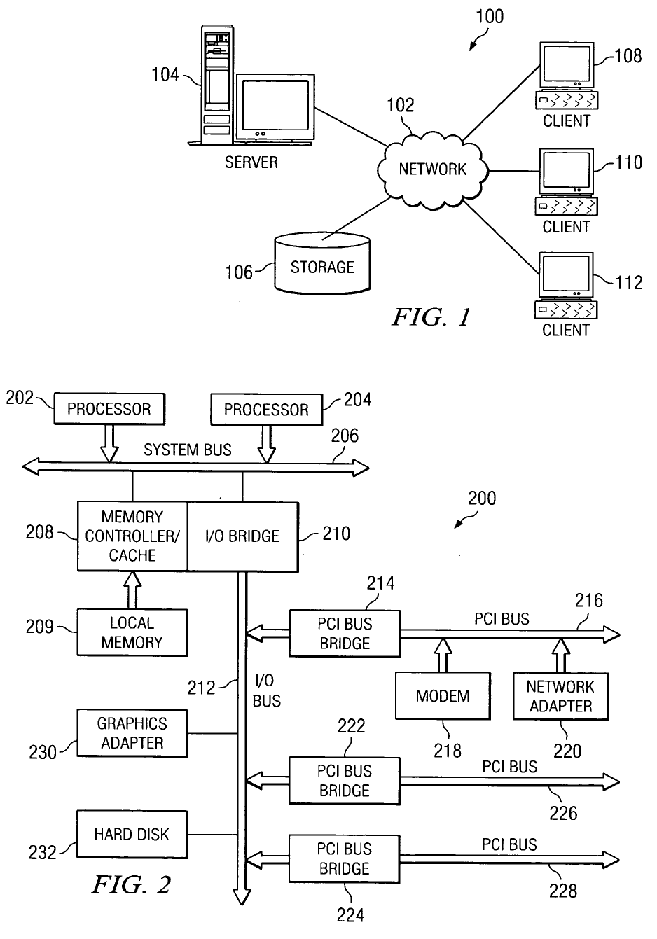

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, New York, running the Advanced Interactive Executive (AIX) operating system or LINUX operating system.

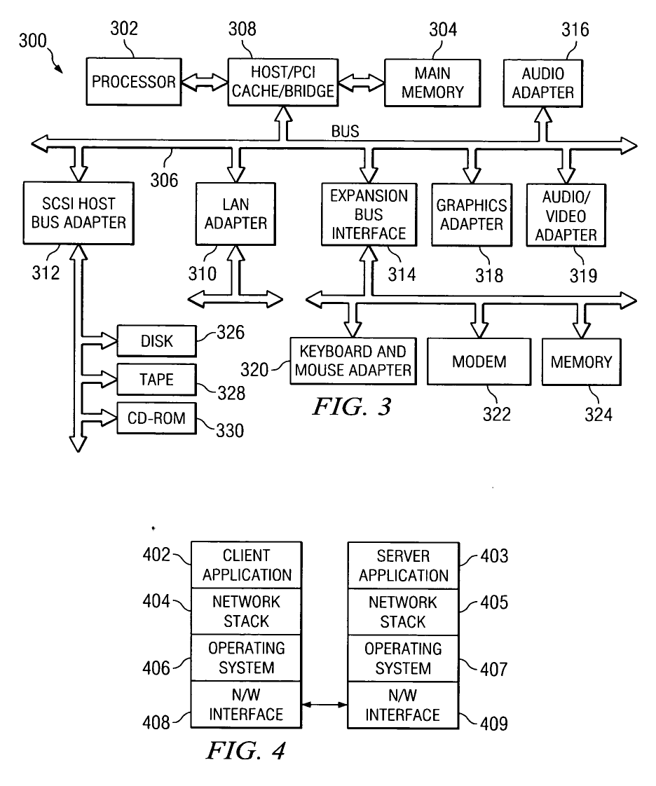

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a diagrammatic illustration of a client-server application in which a preferred embodiment of the present invention may be implemented for advantage. Client application 402 is an example of a computer system application or process that requests a service or data from server application 403. In the illustrative example, client application 402 may be maintained and executed by a client data processing system, such as data processing system 300 shown in FIG. 3, and server application 403 may be maintained and executed by a server data processing system, such as data processing system 200 shown in FIG. 2. Client application 402 and server application 403 exchange data via respective network stacks 404 and 405, e.g., a TCP/IP stack, that interfaces or is integrated with O/S 406 and 407. In the illustrative examples, network stacks 404 and 405 are shown as layered on respective O/S 406 and 407. Typical implementations of network stacks 404 and 405 comprise stack layers integrated within O/S 406 and 407, e.g., within the operating system kernel.

Data transmitted and received by client application 402 and 403 are conveyed over a network, such as network 102 shown in FIG. 1, by network interface devices 408 and 409, e.g., an Ethernet card or other suitable network communication device. Typical implementations of network stack 404 and 405 include respective instances of the Nagle algorithm.

In the illustrative examples below, assume a first identification of a single outstanding acknowledgement of a small segment results in a subsequent small segment of the same TCP session being queued until the outstanding acknowledgment is received. That is, the network stack of a sender in the client-server application is configured to block transmission of a small segment when any previously sent small segment has an outstanding acknowledgement yet to be received by the sender. A transaction processing routine implemented according to a preferred embodiment of the present invention may be included in the network stack of a sender in a client-server application for adjusting the number of allowable outstanding acknowledgments for improved performance of the client-server application as described below.

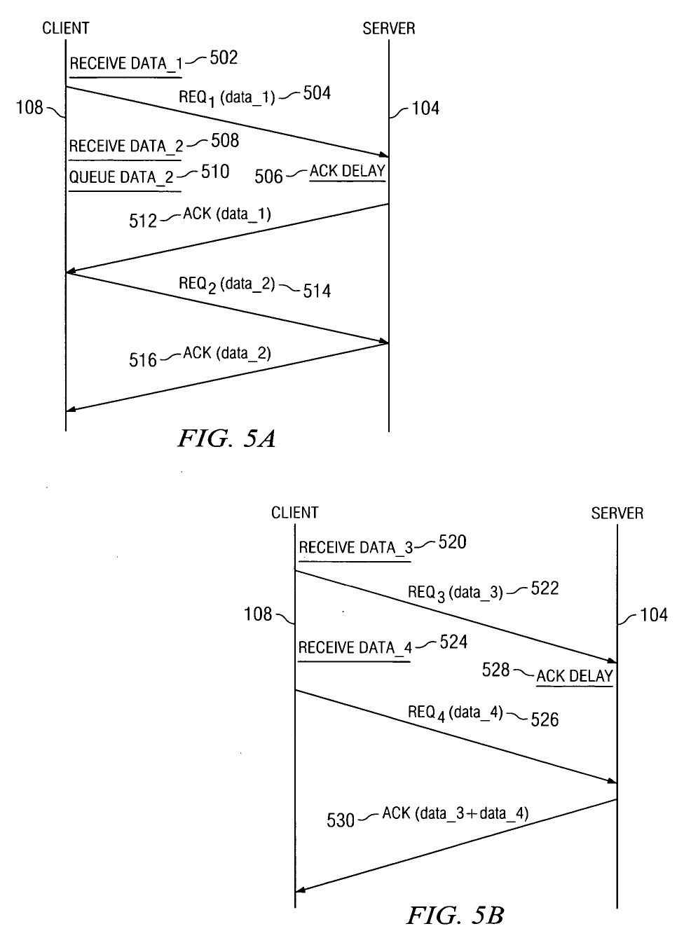

FIG. 5A is a signal flow diagram between a client, such as client 108, and a server, such as server 104, in which the client runs an instance of the Nagle algorithm and the server has a network stack including a delayed acknowledgement function in which a deadlock between the client and server occurs. Assume for illustrative purposes that client application 402 generates a 150 byte request that is to be conveyed to server 104.

Further assume that client application 402 generates the 150 byte request as two separate data sets: a first 50 byte data set (data_1) and a subsequent 100 byte data set (data_2). Upon generation of: the first data set, client application 402 passes the data set, or application data, to network stack 404. Upon receipt of the first data set by network stack 404 (step 502), the 50 byte data set is identified as a small segment and is inserted into a TCP segment. The TCP segment is prepended with an IP header and the resulting IP datagram is then encapsulated in a data link layer frame, e.g., an Ethernet frame. The frame (REQ₁) is then transmitted to server 104 via network interface device 408 (step 504).

On receipt of the frame REQ₁ having the first data set by server 104, a delayed acknowledgement routine executed by server 104 begins decrementing a delayed acknowledgement timer having an initial predefined delay timeout (tₜₒ) that defines a maximum acknowledgment delay interval, typically 200 ms, during which network stack 405 will await additional information, such as application data from server application 403, to transmit to client 108 with the acknowledgement (step 506).

In the present example, client 108 receives the second data set (data_2) of the request from client application 402 during the acknowledgement delay (step 508). Client 108 has yet to receive an acknowledgment of the previously transmitted frame of the TCP session. The Nagle algorithm, having previously identified the first data set as a small segment, queues the second data set upon identification of the second data set as a small segment (step 510). Thus, each of the server 104 and client 108 are in an idle state for the current transaction as indicated by respective steps 506 and 510 client 108 is awaiting receipt of an acknowledgement message acknowledging receipt of the frame containing the small segment including the first data set (data_1) and server 104 is awaiting data from server application 403 to piggyback with the acknowledgement.

In the illustrative example, the data set currently queued by client 108 is part of a scattered write, i.e., a request that is broken into two or more request frames. Thus, server application 403, on receipt of the first data set (data_1), is unable to generate data to be piggybacked with an acknowledgement of frame REQ₁ because the first data set does not constitute a complete request that can be processed by server application 403. Thus, the client-server application has entered a deadlocked state that is only resolved upon expiration of the delayed acknowledgement timer.

Upon expiration of the delayed acknowledgement timer, server 104 transmits an acknowledgement of receipt of the first data set to client 108 (step 512). Thus, client 108 does not receive an acknowledgement until expiration of a duration comprising the sum of the bi-directional transmission time, i.e., the round trip time, between client 108 and server 104 and the delayed acknowledgement timeout duration. The sum of the round trip time between client 108 and server 104 and the delayed acknowledgement timeout duration is herein referred to as a minimum Nagle-delayed acknowledgement induced transmission latency or interval. On receipt of the acknowledgement, client 108 may then transmit the queued frame (REQ₂) including the small segment having the second data set to server 104 (step 514). Server 104 may then return an acknowledgement message to client 108 (step 516) or, alternatively, enter another delay cycle.

In accordance with a preferred embodiment of the present invention, the number of small segments transmitted from a sender that may have a respective outstanding acknowledgement is adjusted when a sender-receiver deadlock state is identified. In the illustrative examples, the sender-receiver deadlock state is a Nagle-delay acknowledgement induced deadlock between client 108 and server 104. Particularly, the present invention provides a mechanism for increasing the number of allowed outstanding acknowledgements when a Nagle-delayed acknowledgement deadlock state is identified.

For example, on receipt of the first segment acknowledgement shown according to step 512, the transaction processing routine may evaluate the client-server transaction as having a Nagle-delayed acknowledgement induced latency. In a preferred embodiment of the present invention, the transaction processing routine evaluates the duration during which client 108 blocks, or queues, a segment for transmission while awaiting an acknowledgment of a previously transmitted segment. A queue time identified as equaling or exceeding a deadlock threshold timeout is used as identification of a sender-receiver deadlock state. In a particular implementation, a deadlock threshold is a sum of a bi-directional transmission duration between the sender and receiver and the delayed acknowledgment timeout duration. In response to identification of a deadlock state, the transaction processing routine then increments the number of allowable outstanding acknowledgements associated with small segments transmitted by a sender to improve the client-server application performance.

FIG. 5B is a signal flow diagram between a client and a server in which the number of allowable outstanding acknowledgements has been increased for improved client-server application performance in accordance with a preferred embodiment of the present invention. FIG. 5B is intended to illustrate a continuation of a common TCP session described above in FIG. 5A. Assume for illustrative purposes that the transaction processing routine identified, responsive to receipt of the acknowledgement of the first data segment, a sender-receiver deadlock in the client server transaction shown in FIG. 5A and has increased the allowable number of outstanding acknowledgements by one. Accordingly, network stack 404 may now transit two small segments in a common TCP session prior to receiving an acknowledgment for either of the small segments.

Similar to the transaction described in FIG. 5A, assume client application 402 generates a 150 byte request that is to be conveyed to server 104. Further assume that client application 402 generates the 150 byte request as two separate data sets: a first 50 byte data set (data_3) and a subsequent 100 byte data set (data_4). Upon generation of the first data set, client application 402 passes the data set to network stack 404. Upon receipt of the first data set by network stack 404 (step 520), the 50 byte data; set is inserted into a TCP segment. The TCP segment is prepended with an IP header and the resulting IP datagram is then encapsulated in a data link layer frame. The frame (REQ₃) is then transmitted to server 104 via network interface device 408 (step 522). After transmission of the frame REQ₃, the second data set (data_4) is received by network stack 404 (step 524).

In accordance with an embodiment of the present invention, client 108 evaluates the number of outstanding acknowledgements of previously transmitted small segments. For example, the number of outstanding acknowledgments may be compared to a variable that defines the number of allowable outstanding acknowledgments. In the event the number of outstanding acknowledgments is less than the number of allowable outstanding acknowledgements, the currently received segment may then be transmitted. In the present example, the number of allowable outstanding acknowledgements has previously been incremented from one to two, and thus client 108 transmits the second frame of the request (step 526).

After receipt of the first frame (REQ3), server 104 enters an acknowledgment delay by initiating decrements to the acknowledgment delay timer (step 528). Upon receipt of the second transmitted frame, the request is then processed and an acknowledgement and return data (if any) may then be transmitted from server 104 to client 108 (step 530). Thus, a sender-receiver deadlock state is avoided and server 104 only remains in an acknowledgment delay for the duration elapsing from receipt of the first frame (REQ3) of the request until return of application data by server application 403 after receipt of the second request segment in the second frame (REQ4).

Acknowledgment delays encountered in transaction sequences sharing transaction characteristics are thus reduced. In the above examples, a first transaction including data sets data_1 and data_2 resulted in a client-server deadlock due to the sending network stack 404 blocking transmission of the second segment of the request to await receipt of an acknowledgment of the first segment. Upon identification of the client-server deadlock, a subsequent transaction comprising first and second small segments does not result in a block of the second segment of the transaction as the number of allowable outstanding acknowledgements had been previously increased responsive to identification of the earlier deadlock state.

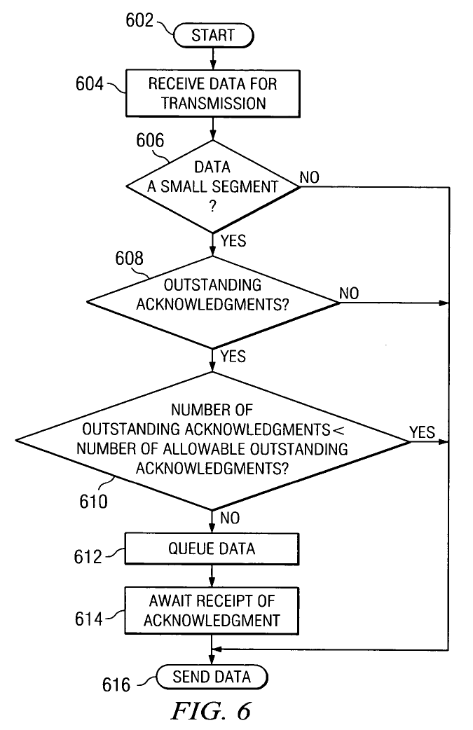

FIG. 6 is a flowchart of a transaction processing routine for evaluating a number of outstanding acknowledgments in accordance with a preferred embodiment of the present invention. The transaction processing routine is initialized, for example of boot of data processing system 300 shown in FIG. 3 (step 602). The transaction processing routine then awaits receipt of data for transmission to a receiver, such as server 104 (step 604). The received data is evaluated to determine if the data may be classified as a small segment and thus subject to transmission blocking by the Nagle algorithm (step 606). The data is then transmitted if it is not evaluated as a small segment (step 616). If the data is evaluated as a small segment at step 606, the transaction processing routine proceeds to determine if the session to which the received data belongs has any outstanding acknowledgments (step 608). In the event there are no outstanding acknowledgements, the data is then transmitted according to step 616.

If any outstanding acknowledgments are identified for the session to which the received data belongs, the number of outstanding acknowledgments is compared with a number of allowable outstanding acknowledgments (step 610). If the number of outstanding acknowledgments is less than the number of allowable outstanding acknowledgments, the data is then transmitted according to step 616. In the event the number of outstanding acknowledgements is not less than the number of allowable outstanding acknowledgments, the data is then queued (step 614) and the transaction processing routine proceeds to await receipt of an acknowledgment (step 614). On receipt of an acknowledgment, a queued data set may then be transmitted according to step 616.

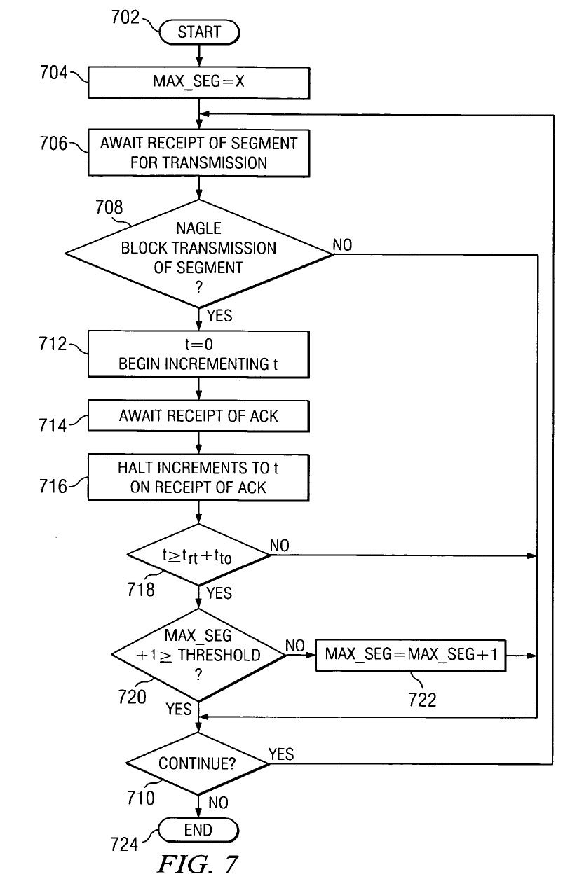

FIG. 7 is a flowchart of a transaction processing routine that may be implemented in a network stack of a data processing system, such as data processing system 300 shown in FIG. 3, in accordance with a preferred embodiment of the present invention. The transaction routine is initialized (step 702), for example on boot of data processing system 300 shown in FIG. 3. A variable (Max_Seg) that defines an allowable number of outstanding acknowledgments of a sender is initialized to a predefined value (X) (step 704). For example, the allowable number of outstanding acknowledgments may be initially set to 1. The transaction processing routine then awaits receipt of a segment for transmission (step 706). On receipt of a segment for transmission, the transaction routine evaluates whether transmission of the segment is blocked due to the Nagle algorithm running on client 108 (step 708). In the event the frame is transmitted, the transaction routine proceeds to evaluate whether additional transactions are to be processed (step 710) and returns to step 706 to await receipt of additional segments for transmission. Alternatively, the transaction routine terminates (step 724).

Returning again to step 712, in the event that a Nagle algorithm-based frame transmission block is identified, the sender, e.g., client 108, initializes a counter (t) to zero and begins incrementing the counter (step 712). Counter t accumulates a duration measure of the time that passes between identification of a frame blocked from transmission and receipt of an acknowledgement message of the TCP session to which the blocked frame belongs.

Thus, the transaction routine awaits receipt of the acknowledgement message (step 714) and halts increments to the counter t upon receipt of the acknowledgement message (step 716). The transaction routine subsequently evaluates the duration during which the frame was blocked from transmission with a sender-receiver deadlock duration threshold (step 718). For example, the time recorded by timer t may be compared with a deadlock duration threshold comprising a sum of a bi-directional roundtrip duration between the sender and the receiver (tᵣₜ) and the delayed acknowledgement timeout duration (tₜₒ). In the event the elapsed time t is less than the deadlock duration threshold, the transaction processing routine returns to step 710 to evaluate whether additional transactions are to be evaluated.

If, however, the elapsed time t equals or exceeds the deadlock duration threshold, a comparison of the number of allowable outstanding acknowledgments is made with a predefined outstanding acknowledgments threshold (threshold) that defines an upper limit to which the transaction processing routine may adjust the number of allowable outstanding acknowledgements (step 720). If the number of allowable outstanding acknowledgments equals or exceeds the predefined outstanding acknowledgments threshold, the transaction processing routine returns to step 710 to evaluate whether additional transaction evaluations are to be made. If however, the allowable number of outstanding acknowledgements is less than the outstanding acknowledgments threshold, the number of allowable outstanding acknowledgments is incremented (step 722), and the transaction processing routine returns to step 710 to evaluate whether additional transactions are to be evaluated.

In the event that the number of allowable outstanding acknowledgments is incremented at step 722, a subsequent client-server message exchange having a similar request and response constituency will be performed with a reduced latency. The sender is incrementally allowed to issue a greater number of small segments before being required to queue a small segment for transmission. Thus, requests that are broken into multiple small segments are less likely to induce a full delayed acknowledgment timeout at the receiver.

As described in the illustrative examples, a routine is provided for improving performance of transaction oriented client-server applications. The transaction processing routine of the present invention reduces the occurrence of sender-receiver deadlock delays encountered when performing multiple small writes in a client-server application running an instance of the Nagle algorithm on the sender side and a delayed acknowledgement routine on the receiver side. The transaction processing routine provides self-tuning by identifying sender-receiver deadlocks and adjusting the number of allowable outstanding acknowledgments accordingly.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of processing transactions of a client-server application, the method comprising the computer implemented steps of:
sending a first data set from a client to a server;
receiving a second data set at the client to be transmitted to the server;
evaluating whether transmission of the second data set is blocked until receipt of an acknowledgment of the first data set; and
responsive to determining that the second data set is blocked, increasing a number of allowable outstanding acknowledgements.

2. The method of claim 1, wherein increasing the number of allowable outstanding acknowledgments further includes:
comparing the number of allowable outstanding acknowledgments with an allowable acknowledgments threshold, wherein increasing the number of allowable outstanding acknowledgements is performed responsive to determining that the number of allowable outstanding acknowledgments is less than the threshold.

3. The method of claim 1, further including:
responsive to evaluating the second data set as blocked, measuring a duration that the second data set is queued for transmission.

4. The method of claim 3, further including:
comparing the duration with a deadlock duration threshold.

5. The method of claim 4, wherein the deadlock duration threshold comprises a minimum Nagle-delayed acknowledgment induced transaction latency.

6. The method of claim 4, wherein the deadlock duration threshold comprises a sum of a bi-directional round-trip duration between the client and the server and a delayed acknowledgment timeout duration.

7. A computer program product in a computer readable medium for processing transactions of an application, the computer program product comprising:
first instructions that receive a first segment and a second segment for transmission;
second instructions that determine transmission of the second segment is blocked; and
responsive to determining transmission of the second segment is blocked, third instructions that increase an allowable number of outstanding acknowledgements.

8. The computer program product of claim 7, further including:
fourth instructions that determine a duration during which transmission of the second segment is blocked.

9. The computer program product of claim 8, further including:
fifth instructions that compare the duration with a threshold that defines a deadlock state in which the application awaits an acknowledgment of transmission of the first segment.

10. The computer program product of claim 9, wherein the third instructions increase the allowable number of outstanding acknowledgements responsive to the comparison indicating the duration is greater or equal to the threshold.

11. The computer program product of claim 9, wherein the threshold is a sum of a bi-directional transmission duration between a client and a server and a delayed acknowledgment timeout duration.

12. The computer program product of claim 8, wherein the duration is an interval measured from when the second segment is queued for transmission to receipt of an acknowledgment of a previously transmitted segment.

13. The computer program product of claim 7, further including:
fourth instructions that compare the allowable number of outstanding acknowledgements with a maximum allowable outstanding acknowledgements threshold.

14. A data processing system for processing transactions of an application, comprising:
a memory that contains a transaction processing routine as a set of instructions;
a network adapter that transmits a first segment and receives an acknowledgment of the first segment; and
a processing unit, responsive to execution of the set of instructions, that identifies a second segment as blocked for transmission and increments a number of allowable outstanding acknowledgements responsive to identifying the second segment as blocked.

15. The data processing system of claim 14, wherein the processing unit measures a duration during which the second segment is queued.

16. The data processing system of claim 15, wherein the duration exceeds a deadlock threshold comprising a sum of a predefined delayed acknowledgement timeout duration and a bi-directional round trip transmission duration between a sender and receiver in a client-server configuration.

17. The data processing system of claim 14, wherein the second segment is queued until a receipt acknowledgment of the first segment is received by the network adapter.

18. The data processing system of claim 14, wherein the processing unit compares the number of allowable outstanding segments with a maximum allowable outstanding acknowledgements threshold.

19. The data processing system of claim 14, wherein the processing unit identifies the first segment and the second segments as having a respective segment size less than a maximum segment size.

20. The data processing system of claim 14, wherein the set of instructions are integrated in a network stack.
